(19) United States
(12) Patent Application Publication
(10) Pub. No.: US 2022/0136602 A1
(43) Pub. Date: May 5, 2022

(54) Shift Element for a Vehicle Gearbox

(71) Applicant: KNORR-BREMSE Systeme fuer Nutzfahrzeuge GmbH, Muenchen (DE)

(72) Inventor: Florian FROEHLICH, Muenchen (DE)

(21) Appl. No.: 17/430,182

(22) PCT Filed: Jan. 24, 2020
(86) PCT No.: PCT/EP2020/051815

§ 371 Date: Aug. 11, 2021

(30) Foreign Application Priority Data
Feb. 12, 2019 (DE) 10 2019 103 488.4

(51) Int. Cl. F16H 63/32; F16H 63/30

(52) U.S. Cl. CPC F16H 63/32; F16H 2063/3063; F16H 2063/3059; F16H 63/304

(57) ABSTRACT

A shift element for a vehicle gearbox is designed to be displaced parallel to an actuation direction. The shift element has a mechanism which is designed to convert a drive movement applied to a drive interface of the mechanism into a displacement of the shift element parallel to the actuation direction.

### BACKGROUND AND SUMMARY OF THE INVENTION

The present invention relates to a shift element for a vehicle gearbox, an actuator having such a shift element and a vehicle gearbox having a shift element or having an actuator.

In vehicle construction, attempts are always made to find the most space-saving construction solutions possible in order to ensure that the largest possible number of functions can be carried out in a limited space. If a vehicle has a vehicle gearbox which can be shifted by means of a shift element, this shift element or an actuator having such a shift element take up a relatively large amount of space. This is inter alia a result of the fact that it is necessary to provide elements which are constructed to convert a drive movement into a displacement of the shift element in an activation direction and for the transmission thereof.

Therefore, an object of the present invention is to provide a possibility of providing a space-saving solution for such vehicle gearboxes.

This object is achieved by the aspects of subject-matter of the independent claims. The dependent claims relate to advantageous developments.

According to the invention, there is provided a shift element for a vehicle gearbox which is constructed to be displaced parallel with an activation direction, wherein the shift element has a mechanism which is constructed to convert a drive movement which is applied to a drive interface of the mechanism into a displacement of the shift element parallel with the activation direction.

The shift element is preferably constructed to move into engagement with an element of the vehicle gearbox in order to displace this element and thereby to adjust a shift position in the vehicle gearbox. The element may in this instance, for example, be a shift collar or the like. The element is preferably constructed to adjust a travel stage or a gear of the vehicle gearbox or to release it again by means of a displacement of the shift element into a shift position.

Preferably, the drive movement is constructed as a rotational movement. However, the drive movement may alternatively also be constructed as another, preferably linear movement.

Alternatively or additionally, the activation direction is preferably constructed in a linear manner. However, the activation direction may also be in another form, preferably a circular form.

In the case of a circular construction of the activation direction, the shift element is preferably not constructed to be displaced as a whole parallel with the activation direction. Instead, the shift element is constructed in this instance to carry out a rotational movement, wherein a location on the shift element is moved in an activation direction. This is also referred to below as a “rotational displacement”.

Preferably, the mechanism has a gearbox which is constructed to convert the drive movement into the displacement of the shift element parallel with the activation direction. The drive interface of the mechanism is in this instance preferably constructed as a gearbox input. The gearbox particularly preferably has a movement thread, a ball screw drive or a combination of a pinion and a rack. As a result of these gearbox types, a conversion of a rotational movement into a translational movement can be achieved. The rotational movement may in this instance be constructed as a drive movement or as a displacement parallel with the activation direction and the translational movement may accordingly be constructed as a displacement parallel with the activation direction or as a drive movement. However, other types of gearboxes are conceivable. For example, there may be provided a gearbox which converts a drive movement into a linear displacement parallel with the activation direction. A gearbox, such as, for example, a toothed gearing, which converts a rotational drive movement into a rotational displacement parallel with the activation direction, may also be provided.

Preferably, the shift element is directly connected to a gearbox output of the gearbox. The gearbox output may in this instance, for example, be a shaft which transmits a rotational movement to the shift element. Preferably, the gearbox output is a nut of a movement thread or a ball screw drive. Such a nut, when introducing a rotational drive movement, will carry out a translational displacement of the shift element parallel with the activation direction. In another embodiment, the gearbox output is configured as a rotationally secure shaft or spindle which is constructed to carry out a displacement parallel with the activation direction, wherein this displacement is preferably brought about by the rotational movement of a nut which is in engagement with the shaft or spindle. In this case, the nut is preferably constructed as a gearbox input of the gearbox or as a drive interface of the mechanism. In this instance, a movement thread or a ball screw drive may also be provided to construct the functionality.

The shift element may particularly preferably be integrally integrated with the gearbox output.

The mechanism is preferably integrated in the shift element. This is distinguished, for example, in that the shift element has a fixed connection to the mechanism at least parallel with the activation direction. In this instance, this connection is preferably provided between the shift element and the gearbox output. The mechanism may further preferably be integrated in the shift element in such a manner that the shift element completely surrounds the mechanism, wherein only one input of the mechanism is further preferably exposed and this is constructed to be moved by the drive movement. The shift element is further preferably guided by a guide parallel with the activation direction.

The shift element is preferably constructed to adjust a shift position in the vehicle gearbox. To this end, the shift element is preferably constructed to move into engagement in a positive-locking manner with an element of the vehicle gearbox or to be in engagement with this element, wherein this element is also displaced by the displacement of the shift element parallel with the activation direction. In a particularly preferred manner, the shift element is constructed as a shift fork.

Preferably, the shift element has a locking mechanism which is constructed to lock the shift element in at least one position parallel with the activation direction. If the locking mechanism is constructed for a position of the shift element which corresponds to a shift position, a shift position can advantageously be locked or secured. An unintentional release of a transmission range is consequently prevented.

The locking mechanism is in a particularly preferred manner constructed as a positive-locking locking mechanism with resilient pretensioning force. This may, for example, be a resiliently loaded ball detent, wherein a ball is positioned on the shift element or in a fixed manner relative to the shift element and the ball is constructed to move into engagement with a corresponding counter-piece, for example, a recess, with specific positions parallel with the activation direction.

Preferably, the shift element has a detection means which is constructed to detect a position of the shift element in the activation direction. In this instance, this may be a position sensor which is constructed to detect the position. Such a detection means may be present in any known embodiment. For example, it may function in accordance with an electromagnetic principle. In a particularly preferred manner, it is constructed as a Hall sensor. Alternatively, from the displacement of the shift element via a mechanical coupling, a movement of another element, for example, a rotational movement, may be brought about. This rotational movement preferably increments a counter, in a particularly preferred manner in the control means, so that the position of the shift element can be derived from the value of the counter.

According to the invention, an actuator for a shiftable vehicle gearbox is provided, having a shift element as described above, wherein the actuator is constructed to adjust at least two shift positions of the vehicle gearbox with the shift element. A compact actuator can thus advantageously be provided for a gearbox.

The actuator further preferably has a guide which is constructed to receive the shift element and which enables the shift element to be guided parallel with the activation direction.

Preferably, the actuator has a drive device which is constructed to apply the drive movement to the mechanism. The drive device is particularly preferably directly connected to the drive interface of the mechanism. The actuator can thus advantageously be supplemented by a drive possibility so that only an energy supply is intended to be provided for it. The drive device is preferably constructed in an electrical manner, for example, as an electric motor or as a linear motor. Alternatively, however, a fluidic, that is to say, in particular a pneumatic or hydraulic, or a mechanical construction may also be possible.

The actuator is preferably constructed to be provided at least partially, in a particularly preferred manner completely, in the vehicle gearbox. To this end, the actuator preferably has a housing which is constructed to fit the actuator inside the vehicle gearbox or on the vehicle gearbox. The housing is further preferably constructed to allow the shift element to extend at least partially into the vehicle gearbox so that it can move into engagement at that location with corresponding elements of the gearbox.

Preferably, the actuator has a control means which is constructed to control the actuator. The control means is preferably constructed as an electronic control means. Such a control means may preferably have an electronic control device which is constructed to control the actuator. In a particularly preferred manner, the control means is constructed to process the position of the shift element detected by the detection means. On the basis of this position, the control of the actuator is carried out by the control means.

Preferably, the actuator has a signal interface which is constructed to receive a control signal in order to control the actuator and/or which is constructed to transmit a status signal of the actuator to a receiver. The control signal is preferably constructed to transmit to the control means a desired shift position which is intended to be adjusted by the actuator in the vehicle gearbox. The control means itself is preferably constructed to establish from the control signal, particularly preferably from the desired shift position and the position of the activation element in the activation direction, a current shift position and to control the actuator accordingly in order to adapt the current shift position to the desired shift position. The status signal preferably contains an information item relating to an existing shift position, that is to say, an actual shift position. This information item may be processed by additional processing means outside the vehicle gearbox.

If no control means is provided in the actuator or if the control means is defective, the control signal received is preferably constructed to control the drive device within the actuator and/or additional elements for operating the actuator or to control or operate the actuator and/or the additional elements directly.

The at least one signal interface is preferably constructed to transmit information items which are obtained within the actuator, for example, by the detection means or by the control means, to another element inside or outside the actuator. As such information items, an actual shift position or a position of the activation element may in particular be transmitted.

The signal interface is preferably constructed to be connected to a vehicle network, such as a CAN-BUS or to a superordinate system, such as a gearbox control device.

Alternatively or additionally, the actuator has an energy interface which is constructed to receive energy for operating the actuator.

Preferably, the at least one signal interface is constructed, in order to receive the control signal, to be connected to an element outside a housing of the vehicle gearbox. The at least one signal interface of the actuator is preferably constructed to extend through the housing of the vehicle gearbox, for example, through an opening of the housing of the vehicle gearbox.

Preferably, the at least one energy interface is constructed, in order to receive the energy, to be connected to an element outside the housing of the vehicle gearbox. The at least one energy interface of the actuator is preferably constructed to extend through the housing of the vehicle gearbox, for example, through an opening of the housing of the vehicle gearbox.

According to the invention, a vehicle gearbox is provided, having:

a shift element as described above, or

an actuator as described above.

The vehicle gearbox is preferably constructed to be shifted by means of the shift element.

Preferably, the vehicle gearbox has at least two shift positions. The shift positions may, for example, be two gears. These include, for example, two forward gears or one forward and one reverse gear. In addition, a neutral position in which no gear is engaged is preferably provided.

Preferably, the vehicle gearbox is constructed for an electrically driven vehicle, Preferably, the vehicle gearbox is constructed for a utility vehicle. In a particularly preferred manner, the vehicle gearbox is constructed for an electrically driven utility vehicle.

The invention is not limited to the embodiments described above. Additional embodiments can further be achieved by means of combination, replacement or omission of individual features.

Preferred embodiments of the invention are described below with reference to the appended drawings.

### BRIEF DESCRIPTION OF THE DRAWINGS

FIG. 1 is a schematic illustration of a shift element according to an embodiment of the invention.

FIG. 2 shows the shift element from FIG. 1 with a drive device.

FIG. 3 is a schematic illustration of an actuator according to an embodiment of the invention.

FIG. 4 is a schematic illustration of another embodiment of an actuator according to the invention.

FIG. 5 is a detailed illustration of an actuator according to the diagram of FIG. 3.

FIG. 6 is a detailed illustration of an actuator according to the diagram of FIG. 4.

### DETAILED DESCRIPTION OF THE DRAWINGS

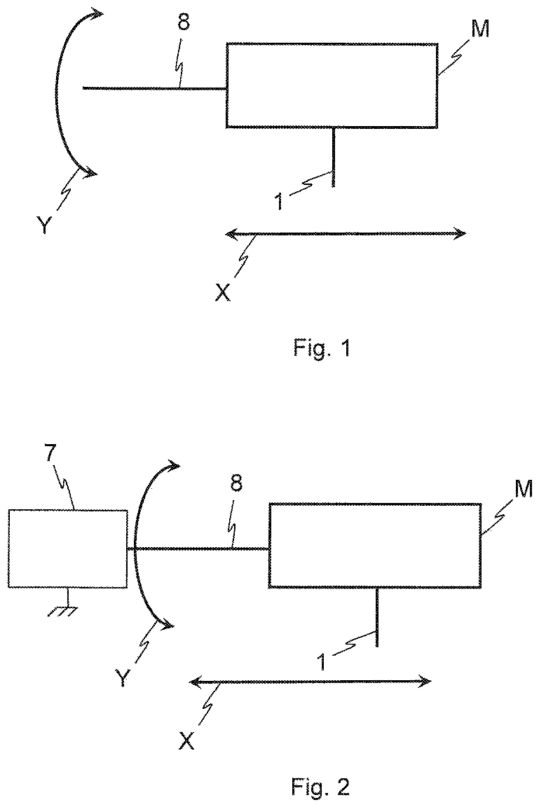

FIG. 1 is a schematic illustration of a shift element 1. This shift element 1 is indicated as an element which extends in a downward direction. At the upper end thereof, this shift element 1 has a mechanism M. The mechanism M has a drive interface 8 which extends to the left. The drive interface 8 is in this embodiment constructed so as to be able to rotate about an axis which is located horizontally in the drawing plane. The drive interface 8 is in this instance constructed, for example, as a shaft. Furthermore, an activation direction X which corresponds in the drawing to a direction from right to left or vice versa is illustrated. Finally, a drive movement Y is illustrated as a rotational movement of the drive interface 8.

The mechanism M is in this instance integrated in the shift element 1 and further constructed to convert the drive movement Y into a displacement of the shift element 1 parallel with the activation direction X. As a result of a drive movement Y which is applied to the drive interface 8, the shift element 1 is consequently displaced parallel with the activation direction X. As a result of the displacement of the shift element 1, a displacement of an element of a vehicle gearbox can be achieved in order to thus adjust a shift position in the vehicle gearbox or to change into a neutral position.

In further embodiments which are not illustrated, the drive movement Y is not constructed as a rotational movement but instead as a translational movement.

In further embodiments which are not illustrated, the activation direction X is not constructed as a translational movement but instead as a rotational or pivot movement.

FIG. 2 shows a possible connection of a drive device 7 to the drive interface 8.

The drive device 7 is constructed to apply the drive movement Y to the drive interface 8 and thus to bring about a displacement of the activation element 1 parallel with the activation direction X.

The drive device 7 is constructed in this instance as an electric motor.

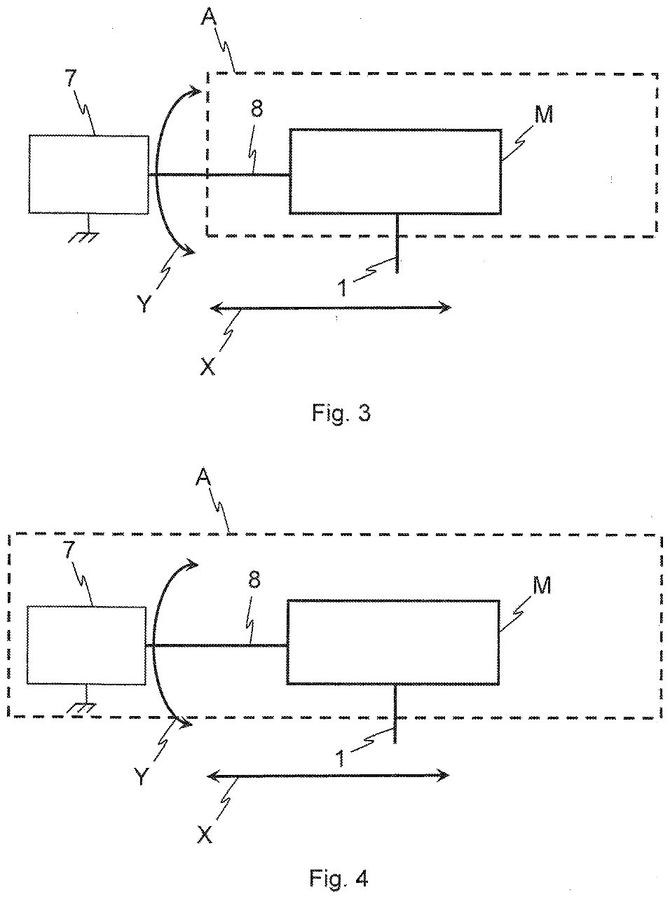

FIG. 3 is a schematic illustration of an actuator A according to an embodiment of the invention. It has substantially the shift element 1 with the mechanism M and the drive interface 8, as described in relation to FIG. 1. The actuator A is constructed to be provided in a vehicle gearbox in order to adjust shift positions therein via the shift element 1.

The actuator A has, in order to be provided in the vehicle gearbox, a housing which is constructed for fitting in the vehicle gearbox. The housing is in this instance depicted as a dashed box.

To the left of the actuator A, there is illustrated a drive device 7 which is connected to the drive interface 8 and which is constructed to apply the drive movement Y to the drive interface 8. The drive device 7 is constructed in this instance as an electric motor.

Otherwise, the operating method of the actuator A is identical to that of the shift element 1 from FIGS. 1 and 2.

FIG. 4 is finally a schematic illustration of another embodiment as a development of the actuator A from FIG. 3. The structure of this actuator A is substantially identical to the actuator A from FIG. 3 but the drive device 7 is now integrated in the housing. This has the advantage that the actuator A can now be installed in its entirety, that is to say, with the drive device 7, in the vehicle gearbox.

Otherwise, the operating method is identical to the actuator A in FIG. 3.

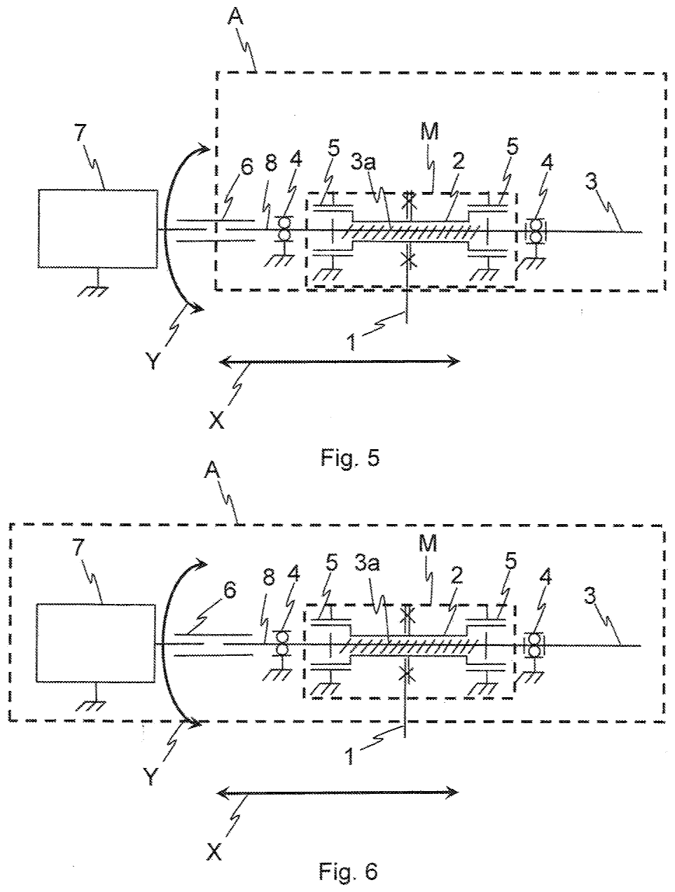

FIG. 5 is a detailed illustration of an actuator A according to the diagram of FIG. 3. The drive device 7 is arranged in this instance outside the actuator A and connected to the drive interface 8 via a coupling 6. The drive interface 8 extends to the right and merges there into a spindle 3 which is supported in the actuator A by means of bearings 4.

The shift element 1 has the mechanism M which is constructed in this instance as follows.

The spindle 3 has at least on a portion of the periphery thereof a thread 3a which is in engagement with a nut 2 which has a corresponding inner thread (not shown). The spindle 3 extends to this end through the nut 2 from left to right, wherein the nut 2 and the spindle 3 are orientated coaxially relative to each other.

The nut 2 is further supported by means of bearings 5 in a rotationally secure manner, but so as to be able to be displaced parallel with the activation direction X so that the shift element 1 can also carry out a displacement of the nut 2 parallel with the activation direction X.

The operating method of the actuator A is as follows.

If a drive movement Y is applied to the drive interface 8 by the drive device 7, the spindle 3 is caused to carry out a rotational movement. The thread 3a on the spindle 3 causes the nut 2 to move parallel with the activation direction X, wherein a simultaneous rotational movement of the nut 2 about the axis of the spindle 3 is prevented by the bearings 5.

The activation element 1 can thereby be displaced parallel with the activation direction X without at the same time moving about the axis of the spindle 3.

FIG. 6 is finally a schematic illustration of another embodiment as a development of the actuator A from FIG. 5. The construction of this actuator A is substantially identical to the actuator A from FIG. 5, but the drive device 7 is now integrated in the housing. This has the advantage that the actuator A can be installed in its entirety, that is to say, with the drive device 7, in the vehicle gearbox.

Otherwise, the operating method is identical to that of the actuator A in FIG. 5.

The embodiments set out here do not have a limiting effect on the subject-matter of the invention. Instead, by adding, replacing or omitting individual features, other embodiments which also represent subject-matter of the present invention can be formed.

First, the embodiment of the mechanism M and shift element 1, as shown in FIGS. 5 and 6, can also be applied to the embodiments which are shown in FIGS. 1 and 2.

The mechanism M may further, in other embodiments in place of a combination of an outer thread 3a on the spindle 3 and inner thread in the nut 2, also have a corresponding ball screw drive. Alternatively, the mechanism M may also have a combination of a pinion and a rack, whereby a conversion of a rotational drive movement Y can also be converted into a translational displacement in the activation direction X.

In other embodiments of the invention, the mechanism has a gearbox which converts a rotational movement Y into a rotational displacement in the activation direction X. The activation direction X is in this instance constructed at least as part of a circular path. Such a gearbox may, for example, be constructed by means of a gear stage.

The drive interface 8 does not necessarily have to be constructed as a shaft which is constructed to carry out a rotational drive movement Y. It can instead also be constructed to absorb a translational drive movement. For example, the drive interface 8 is constructed to this end as a rod.

The drive device 7 shown can further also be constructed as a fluidic, that is to say, as a pneumatic or as a hydraulic drive device 7 or as a purely mechanical drive device 7. With a fluidic construction, there is provided, for example, a piston which is constructed to be able to be acted on with pressure from a fluid and which is further constructed to introduce a displacement, that is to say, a translational drive movement Y into the mechanism M via the drive interface 8. The mechanism M is then constructed, as described above, to accordingly convert the translational drive movement Y. With a mechanical construction of the drive device 7, a linkage or the like may further be provided in order to introduce a displacement into the mechanism M via the drive interface 8.

### LIST OF REFERENCE NUMERALS

1 Shift element
2 Gearbox output
3 Spindle
3a Thread
4 Bearing
5 Bearing
6 Coupling
7 Drive device
8 Drive interface
A Actuator
M Mechanism
X Activation device
Y Drive movement

1.-15. (canceled)

16. A shift element for a shiftable vehicle gearbox which is constructed to be displaced parallel with an activation direction, comprising:
a mechanism which is constructed to convert a drive movement which is applied to a drive interface of the mechanism into a displacement of the shift element parallel with the activation direction.

17. The shift element as claimed in claim 16, wherein
the drive movement is constructed as a rotational movement and/or the activation direction is constructed to be linear.

18. The shift element as claimed in claim 16, wherein
the mechanism has a gearbox which is constructed to convert the drive movement into the displacement of the shift element, and
the gearbox has a movement thread, a ball screw drive or a combination of a pinion and a rack.

19. The shift element as claimed in claim 18, wherein
the shift element is directly connected to a gearbox output of the gearbox.

20. The shift element as claimed in claim 16, wherein
the mechanism is integrated in the shift element.

21. The shift element as claimed in claim 16, wherein
the shift element is constructed to adjust a shift position in the vehicle gearbox, and
the shift element is constructed as a shift fork.

22. The shift element as claimed in claim 16, wherein
the shift element has a locking mechanism which is constructed to lock the shift element in at least one position parallel with the activation direction, and
the locking mechanism is constructed as a positive-locking locking mechanism with resilient pretensioning force.

23. The shift element as claimed in claim 16, wherein
the shift element has a detection mechanism which is constructed to detect a position of the shift element in the activation direction.

24. An actuator for a shiftable vehicle gearbox, comprising:
a shift element as claimed in claim 16, wherein
the actuator is constructed to adjust at least two shift positions of the shiftable vehicle gearbox with the shift element.

25. The actuator as claimed in claim 24, further comprising:
a drive device which is constructed to apply the drive movement to the mechanism, wherein
the drive device is directly connected to the drive interface of the mechanism.

26. The actuator as claimed in claim 25, wherein
the actuator is constructed to be provided at least partially in the vehicle gearbox.

27. The actuator as claimed in claim 24, wherein
the actuator has a control unit which is constructed to control the actuator.

28. The actuator as claimed in claim 16, further comprising:
a signal interface which is constructed to receive a control signal in order to control the actuator and/or which is constructed to transmit a status signal of the actuator to a receiver, and/or
an energy interface which is constructed to receive energy for operating the actuator.

29. A vehicle gearbox, comprising:
a shift element as claimed in claim 16.

30. A vehicle gearbox, comprising:
an actuator as claimed in claim 24.

31. The vehicle gearbox as claimed in claim 29, wherein
the vehicle gearbox has at least two shift positions, is constructed for an electrically driven vehicle, and/or is constructed for a utility vehicle.
